(19) United States
(12) Patent Application Publication
(10) Pub. No.: US 2017/0152913 A1
(43) Pub. Date: Jun. 1, 2017

(54) CLUTCH PACK WITH ROBUST HYSTERESIS

(71) Applicant: Eaton Corporation, Cleveland, OH (US)

(72) Inventor: LUIZ FILIPE SILVA PEREIRA, INDAIATUBA (BR)

(73) Assignee: Eaton Corporation, Cleveland, OH (US)

(21) Appl. No.: 15/364,845

(22) Filed: Nov. 30, 2016

Related U.S. Application Data
(60) Provisional application No. 62/261,031, filed on Nov. 30, 2015.

(51) Int. Cl. F16F 15/121; F16D 3/12; F16D 13/64

(52) U.S. Cl. CPC F16F 15/1216; F16D 13/644; F16D 3/12; F16D 2300/22

(57) ABSTRACT

A hysteresis device assembly comprises a first spacer plate, a second spacer plate, a stack plate, and a hub. The hub engages the second spacer plate. The hysteresis device assembly further comprises a tabbed washer comprising a tab. The tab engages the first spacer plate and the stack plate.

### FIELD

This application relates to a hysteresis device in a clutch pack, where the device comprises a tabbed washer engaged with spacer plates and a stack plate.

### BACKGROUND

Vehicles can benefit from hysteresis packages as part of clutch assemblies to resist long drives under resonant conditions. A traditional hysteresis package clutch pack has only two friction surfaces on a driven hub, which can lead to high heat generation.

Excessive heating of the hysteresis package can occur due to the high power applied to the hysteresis package, a high Bellville spring load, high resonant conditions, or any combination of these conditions.

### SUMMARY

The devices disclosed herein overcome the above disadvantages and improves the art by way of a hysteresis device assembly.

A hysteresis device assembly comprises a first spacer plate, a second spacer plate, a stack plate, and a hub. The hub engages the second spacer plate. The hysteresis device assembly further comprises a tabbed washer comprising a tab. The tab engages the first spacer plate and the stack plate.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a view of a damper disc assembly.

FIG. 2 is a cross-sectional view of a damper disc assembly including a hysteresis device.

FIG. 3 is a section view of a hysteresis device.

FIG. 4A is a view of a hub with two spacer plates.

FIG. 4B is a view of a spacer plate.

FIG. 5A is a view of a tabbed washer engaged with a spacer plate and a stack plate.

FIG. 5B is a view of a spacer plate.

FIG. 5C is a section view of a tabbed washer engaged with a spacer plate and a stack plate.

FIG. 6 is a view of a hysteresis device with four spacer plates.

### DETAILED DESCRIPTION

Reference will now be made in detail to the examples, which are illustrated in the accompanying drawings. Wherever possible, the same reference numbers will be used throughout the drawings to refer to the same or like parts. Directional references such as “left” and “right” are for ease of reference to the figures.

To dissipate the heat generated by operation conditions, a hysteresis device comprises 6 to 8 friction surfaces instead of the traditional 2. The friction surfaces are distributed on multiple spacer plates with interleaved stack plates.

In order to implement the additional friction surfaces, it is necessary to synchronize the friction surfaces. This can be achieved in part via splining. The outer hub can comprise notches for receiving teeth of a first set of driven spacer plates. The combination of an indexing tab on a tabbed washer, and indexing notches on spacer plates and on one or more driven stack plates permits enhanced hysteresis benefits. The driven stack plate can in turn rotationally drive the tabbed washer and indexed spacer plates.

A first set of driven spacer plates are driven independently of a second set of driven spacer plates, and so there is relative motion between the two sets of driven spacer plates. This deviates from the prior art, because the two friction surfaces of the prior art cannot move independently relative to one another. Driving can be via the indexing for one set of spacer plates, while splining drives the other set of spacer plates.

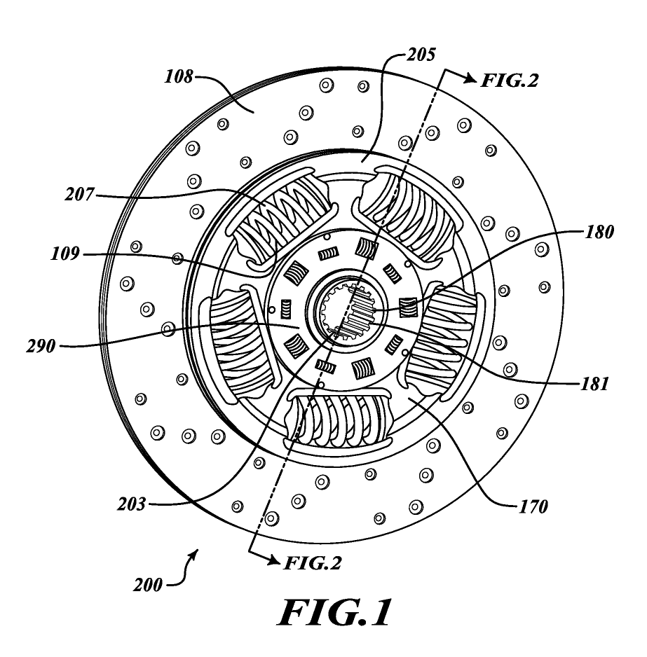

FIG. 1 shows a view of a damper disc assembly 200 of a clutch assembly including a main-damper assembly 170 and a pre-damper assembly 290. Friction disc 108 is attached to main-damper assembly 170. At times, a dual flywheel system is used to transfer torque to a clutch assembly. At other times, a clutch assembly can comprise two of the damper assemblies 200. Or, a clutch assembly can comprise at least two main-damper assemblies 170 and a pre-damper assembly 290.

Automobiles and other vehicles commonly have a clutch assembly as part of a powertrain system. The clutch assembly, which includes a damper disc assembly, can be located between an engine and a transmission assembly. The engine produces torque, which can be transferred to a clutch assembly by a flywheel.

Friction disc 108 can receive torque from a flywheel. Friction disc 108 can transfer torque to torsional springs 207. Torque then travels from torsional springs 207 to cover plates, for example, cover plate 205 on main-damper assembly 170. Cover plate 205 transfers torque to hub 203.

Hub 203 can include inner splines 181 and grooves 180 to engage a shaft (not shown), for example, a shaft leading to a transmission assembly. Torque can travel from hub 203 to a transmission assembly and then to wheels, thereby rotating the wheels and accelerating an affiliated vehicle. Torque can also travel in the reverse direction, for example, during deceleration when one engages the vehicle's brakes.

A plurality of torsional springs 207 are located in apertures 109 of main-damper cover plate 205 about hub 203. Torsional springs 207 can absorb shock experienced during rapid acceleration or deceleration. Torsional springs 207 can also damp vibrations. Pre-damper assembly 290 can also damp vibrations, often damping vibrations occurring when the associated clutch assembly operates at lower torques.

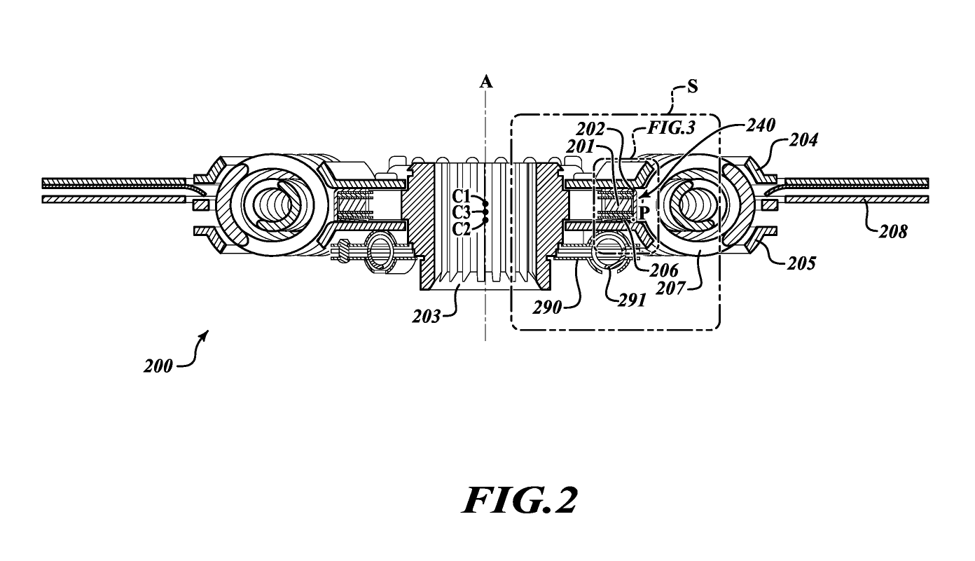

FIG. 2 is a view along the section line FIG. 1. FIG. 2 shows a cross-sectional view of a damper disc assembly 200 of a clutch assembly comprising a friction disc 308, a stack plate 201, and a hub 203. Stack plate 201 has a first center C1. Hub 203 has a second center C2. Axis A passes through first center C1 and second center C2.

A hysteresis device assembly 240 can be located between the first main-damper cover plate 204 and the second main-damper cover plate 205. Hysteresis device assembly 240 can dissipate heat experienced by damper disc assembly 200. The heat generated at hysteresis device assembly 240 can be higher at lower torques, for example, at idle speeds under resonant conditions.

Hysteresis device assembly 240 can include a biasing device 206, which comprises a third center C3. Tabbed washer 202 prevents biasing device 206 from moving past point P away from axis A. In other words, the tabbed washer 202 can be positioned such that third center C3 of biasing device 206 does not move away from axis A in the radial direction.

Biasing device 206 can be a Belleville spring. The spring load applied by biasing device 206 can increase the heat experienced by hysteresis device assembly 240. By including the tabbed washer, the spring force of the biasing device 206 can be reduced, and then less heat is generated. Overall, the hysteresis device assembly 240 experiences less heat fatigue over prior art devices.

A friction disc 208 can be attached to stack plate 201. Torsional spring 207 is located between first main-damper cover plate 204 and second main-damper cover plate 205.

Damper disc assembly 200 can include a pre-damper assembly 290 with torsional springs 291 located about axis A.

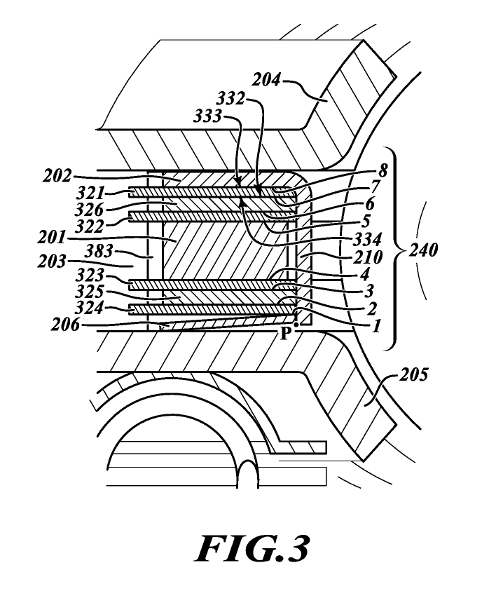

FIG. 3 is a view of section S of FIG. 2. A portion of a damper disc assembly 200 including a hysteresis device assembly 240 is located between first main-dam per cover plate 204 and second main-damper cover plate 205. Hysteresis device assembly 240 includes a tabbed washer 202 and a main-damper stack plate 201. Spacer plates 321, 322, 323, and 324 are connected to hub 203. Tabbed washer 202 can engage stack plate 201 and spacer plates 325, 326 such that tabbed washer 202, main-damper stack plate 201, and spacer plates 325, 326 rotate together.

Spacer plates 325 and 326 make up a first set of spacer plates. Spacer plates 321, 322, 323, and 324 make up a second set of spacer plates. Hub 203 can directly engage the second set of spacer plates.

The first set of spacer plates are driven independently of the second set of spacer plates, and so there can be relative rotation between the two sets of spacer plates. Tabbed washer 202 and main-damper stack plate 201 can rotate together with the first set of spacer plates. As such, there can be relative rotation between the second set of spacer plates and the tabbed washer 202. Likewise, there can be relative rotation between the second set of spacer plates and the main-damper stack plate.

By increasing the number of spacer plates over the two of the prior art, heat dissipation is improved, and the hysteresis device assembly 240 experiences less heat fatigue over prior art devices.

To dissipate the heat generated by operation conditions, the instant hysteresis device assembly can comprises multiple friction surfaces, for example, six to eight friction surfaces instead of the traditional two. The friction surfaces are distributed on multiple spacer plates of the hysteresis device assembly. By increasing the number of friction surfaces, it is possible to work with a lower spring load. The lower spring load reduces wear on moving parts.

Tabbed washer 202 can rotate relative to spacer plate 321 when tabbed washer 202 is not engaged with spacer plate 321 at contact area 8. Likewise, spacer plate 326 can rotate relative to spacer plate 322 when spacer plate 326 is not engaged with spacer plate 322 at contact area 7. Hysteresis device assembly 240 can be arranged such that main-damper stack plate 201, first set of spacer plates 325, 326 and tabbed washer 202 can all rotate or oscillate relative to second set of spacer plates 321, 322, 323, and 324.

Tabbed washer 202 can rotate relative to main-damper stack plate 201 to a limited extent in that tabbed washer 202 can rotate relative to main-damper stack plate 201 until tabbed washer 202 engages main-damper stack plate 201 via tab 310.

The tab 310 on tabbed washer 202 can contact main-damper stack plate 201. When in contact with tab 310, main-damper stack plate 201 can drive tabbed washer 202. Tab 310 can contact spacer plate 325 and spacer plate 326, thereby driving spacer plates 325, 326. Accordingly, main-damper stack plate 201 can drive tabbed washer 202 and spacer plates 325, 326. In other words, main-damper stack plate 201 can transmit torque to tabbed washer 202, engaging tabbed washer 202. Tabbed washer can engage spacer plates 325, 326, thus, torque can be transmitted from stack plate 201 to tabbed washer 202 and to spacer plates 325, 326.

Hysteresis device assembly 240 includes a biasing device 206. Biasing device 206 can be a wave spring, Belleville washer, or other biasing device known to one skilled in the art. Tabbed washer 202 prevents biasing device 206 from moving past point P in the radial direction. Biasing device 206 exerts a force on spacer plate 324. Biasing device 206 can also damp vibrations. When the biasing device 206 provides compression to all the spacer plates, the first set of spacer plates can be frictionally engaged with the second set spacer plates. The stack plate is also frictionally engaged. The combination creates frictional torque, or hysteresis.

Biasing device 206 engages spacer plate 324 at contact area 1, pushing the spacer plates, the main-damper stack plate 201, and tabbed washer 202 together, creating at least eight contact areas 1, 2, 3, 4, 5, 6, 7, and 8.

Contact area 1 is located where biasing device 206 contacts spacer plate 324. Contact area 2 is located where spacer plate 324 contacts spacer plate 325. Contact area 3 is located where spacer plate 325 contacts spacer plate 323. Contact area 4 is located where spacer plate 323 contacts main-damper stack plate 201. Contact area 5 is located where main-damper stack plate 201 contacts spacer plate 322. Contact area 6 is located where stack plate 322 contacts spacer plate 326. Contact area 7 is located where spacer plate 326 contacts spacer plate 321. Contact area 8 is located where spacer plated 321 contacts tabbed washer 202.

Having multiple contact areas increases the area where heat can be dissipated. This results in less total heat generation during operation. With less heat generation, parts wear at a slower rate. Also, biasing device 206 need not exert as much spring force as required by an assembly having less contact area.

The tabbed washer 202, main-damper stack plate 201, and spacer plates 321, 322, 323, 324, 325, 326 can rotate together when engaged at the contact areas. For example, surface 334 of spacer plate 321 can engage surface 332 of spacer plate 326. In a similar manner, spacer plate 326 can engage spacer plate 322 because spacer plate 326 abuts spacer plate 322. Spacer plate 322 can engage main-damper stack plate 201. Main-damper stack plate 201 can engage spacer plate 323. And spacer plate 323 can engage spacer plate 325. Spacer plate 325 can engage spacer plate 324, which abuts biasing device 206.

Any of the spacer plates, including the surfaces of any of the spacer plates, can comprise hardened steel. The surfaces of any of the spacer plates, for example surface 334 of spacer plate 321 and surface 332 of spacer plate 326, can comprise a friction coating. A friction coating can improve the engagement and result in less heat generated during operation. Both sides of a spacer plate can comprise a friction coating, or only a single side of a spacer plate can comprise a friction coating. Omitting a friction coating on a surface of one or more spacer plate can be selected for controlling heat generation.

When engaged with the second set of spacer plates (spacer plates 321, 322, 323, and 324), the tabbed washer 202, main-damper stack plate 201, and first set of spacer plates (spacer plates 325, 326) can transfer torque to the second set of spacer plates. The second set of spacer plates can then transfer torque to the outer portion 383 of hub 203. The lower portion 382 of spacer plate 321 can engage the outer portion 383 of hub 203 via splines and grooves, teeth and channels, or other methods of engagement as known by one in the art.

This engagement and transfer of torque can occur at lower torques, for example, when an engine operates at idle speeds or rotates a flywheel at substantially constant revolutions per minute.

When the engine operates or rotates a transmission assembly at a natural frequency, heat is generated in the damper disc assembly. Heat can then flow to other parts of the vehicle, including a gear box or transmission assembly. The hysteresis devices described herein can reduce the amount of heat generated by using multiple spacer plates and a tabbed washer that engages a plurality of spacer plates.

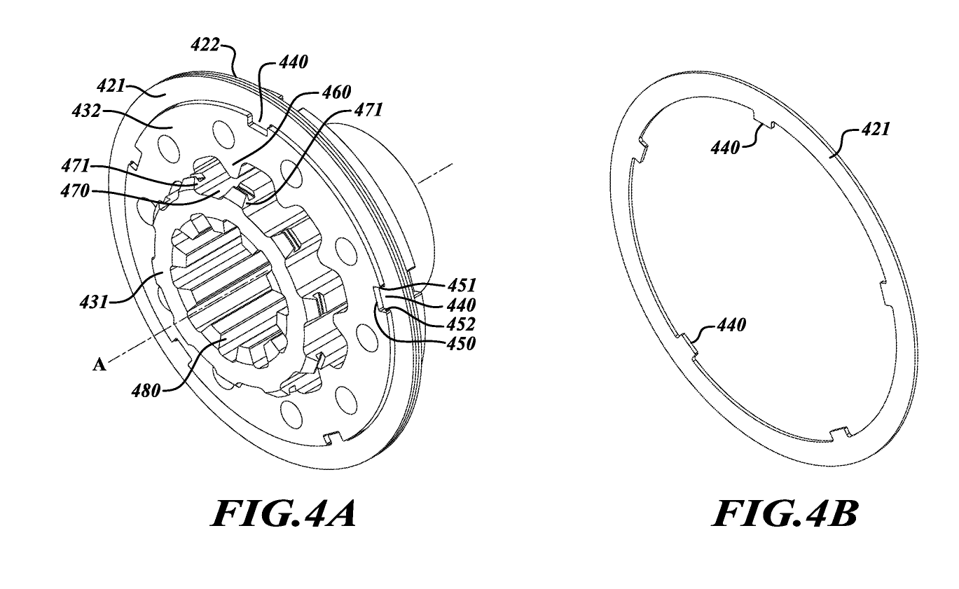

FIG. 4A shows an inner hub 431 with an outer hub 432 and spacer plates 421, 422. FIG. 4B shows an example of an individual spacer plate 421 with projections 440. Spacer plates 421, 422 can each contain projections like projections 440. Projection 440 fits into slot 450 on outer hub 432. Projection can engage slot 450 at first slot wall 451 or second slot wall 452. Spacer plates 421, 422 can rotate with outer hub 432. Outer hub 432 can engage more than two spacer plates. For example, outer hub 432 can engage four spacer plates, as shown in FIG. 3, which depicts hub 203 engaging four spacer plates 321, 322, 323, 324. The number of spacer plates engaging outer hub 432 can be selected based on the desired features of the hysteresis assembly and damper disc assembly. More spacer plates can reduce the amount of heat generated, while less spacer plates can make the assembly more compact.

Outer hub 432 can engage inner hub 431 via teeth 460 on outer hub 432 and channels 470 on inner hub 431. Channels 470 can be located between teeth 471 on inner hub 431. The width of channels 470 and width of teeth 460 can be adjusted to allow inner hub 431 to rotate more or less relative to outer hub 432, depending on the desired amount of play between inner hub 431 and outer hub 432.

Inner hub 431 can include internal splines 480, which can engage a shaft (not shown), for example, a shaft leading to a transmission assembly.

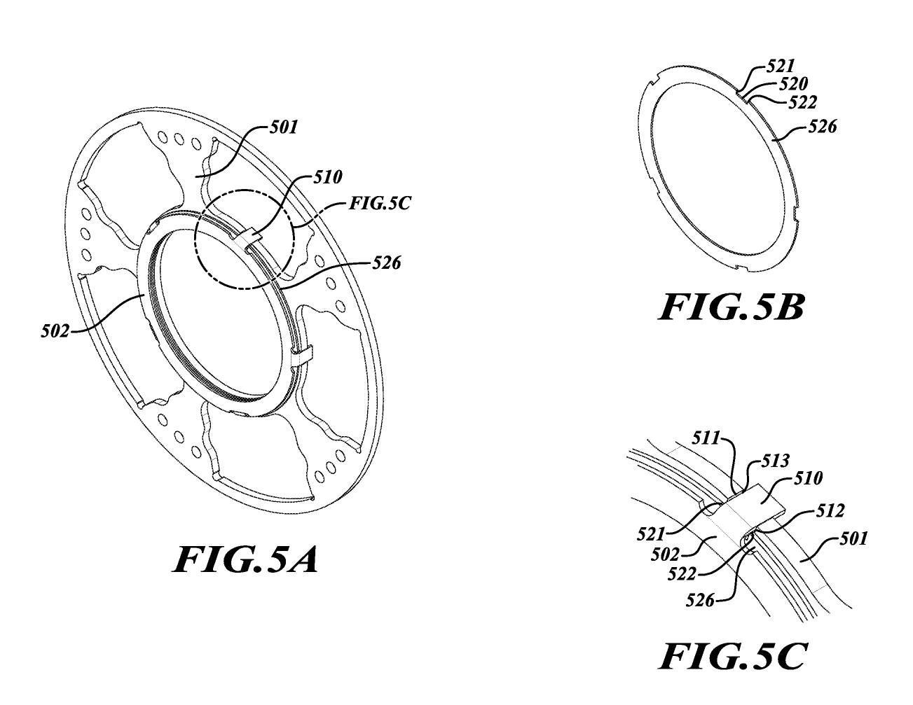

FIG. 5A shows and example of how a tabbed washer 502 can engage a spacer plate 526 and a main-damper stack plate 501. Main-damper stack plate 501, spacer plate 526, and tabbed washer 502 can rotate together when spacer plate 526 and main-damper stack plate 501 are engaged with tab 510 on tabbed washer 502. FIG. 5B shows an example of a spacer plate 526 with a notch 520, having first notch wall 521 and second notch wall 522. Tab 510 of tabbed washer 502 can engage notch 520 at first notch wall 521 and second notch wall 522.

FIG. 5C shows how tab 510 of tabbed washer 502 can engage spacer plate 526 at second notch wall 522 and main-damper stack plate 501 at second notch wall 522. Tab 510 can also engage first notch wall 511 of notch 513 of main-damper stack plate 501, for example, when tabbed washer rotates in a counter-clockwise direction. One can modify the width of notch 513 in main-damper stack plate 501 and the width of notch 520 in spacer plate 526 to achieve a desired result. A larger width can increase the amount of relative rotation allowed between the tabbed washer 501, spacer plate 526, and main-damper stack plate 501. This can also make assembly easier. A smaller width can result in a tighter fit and less relative rotation.

One can increase the number of spacer plates connected to tabbed washer 502. For example, as shown in FIG. 3, tabbed washer 202 engages spacer plate 326 and spacer plate 325. One can increase the number of spacer plates to reduce the amount of heat generated by a hysteresis assembly.

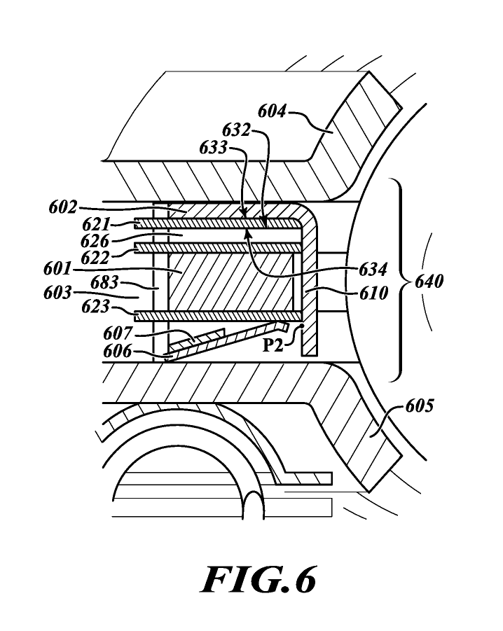

FIG. 6 shows a cross-section view of a hysteresis device assembly 640 with four spacer plates located between first main-damper cover plate 604 and second main-damper cover plate 605. Tabbed washer 602 engages spacer plate 626 and stack plate 601. Spacer plates 621, 622, 623 engage hub 603 at the outer portion 683 of hub 603.

Biasing device 606 exerts a force on spacer plate 623 and second main-damper cover plate 605. Spacer 607 can be positioned to place biasing device 606 in a desired position. Tab 610 can prevent biasing device 606 from moving in the radial direction past point P2. The force exerted by biasing device 606 can compress spacer plate 623 against stack plate 601. Stack plate 601 presses against spacer plate 622. Spacer plate 622 presses against spacer plate 626. Spacer plate 626 presses against spacer plate 621 and spacer plate 621 presses against tabbed washer 602.

Tab 610 of tabbed washer 602 can engage spacer plate 626 and stack plate 601 such that tabbed washer 602, spacer plate 626, and stack plate 601 rotate together. Tabbed washer 602, spacer plate 626, and stack plate 601 can rotate or oscillate relative to spacer plates 621, 622, 623.

Tabbed washer 602, spacer plate 626, and stack plate 601 can rotate with spacer plates 621, 622, 623 when their surfaces are engaged via a friction force. For example, surface 634 of spacer plate 621 can engage surface 632 of spacer plate 626. In a similar manner, spacer plate 626 can engage spacer plate 622 because spacer plate 626 abuts spacer plate 622.

The arrangement in FIG. 6 comprises fewer spacer plates than the arrangement in FIG. 3. One skilled in the art might desire fewer spacer plates, depending, for example, on the need to dissipate heat and space available to include spacer plates.

Other implementations will be apparent to those skilled in the art from consideration of the specification and practice of the examples disclosed herein. It is intended that the specification and examples be considered as exemplary only, with the true scope of the invention being indicated by the following claims.

What is claimed is:

1. A hysteresis device assembly comprising:
a first spacer plate;
a second spacer plate;
a stack plate;
a hub wherein the hub engages the second spacer plate; and
a tabbed washer comprising a tab wherein the tab engages the first spacer plate and the stack plate.

2. The hysteresis device assembly of claim 1, further comprising an axis, wherein the stack plate comprises a first center and the hub comprises a second center, and wherein the axis passes through the first center and the second center.

3. The hysteresis device assembly of claim 1, wherein the first spacer plate comprises hardened steel.

4. The hysteresis device assembly of claim 1, wherein the first spacer plate comprises a friction coating.

5. The hysteresis device assembly of claim 1, wherein the second spacer plate comprises hardened steel.

6. The hysteresis device assembly of claim 1, wherein the second spacer plate comprises a friction coating.

7. The hysteresis device assembly of claim 1, wherein the first spacer plate is configured to rotate relative to the second spacer plate.

8. The hysteresis device assembly of claim 1, wherein the tabbed washer is configured to rotate relative to the second spacer plate.

9. The hysteresis device assembly of claim 1, wherein the tabbed washer is configured to rotate relative to the first spacer plate.

10. The hysteresis device assembly of claim 1, wherein the tabbed washer is configured to rotate relative to the stack plate.

11. The hysteresis device assembly of claim 1, wherein the tabbed washer is configured to rotate relative to the hub.

12. The hysteresis device assembly of claim 1, wherein the first spacer plate and the second spacer plate are configured to damp vibrations.

13. The hysteresis device assembly of claim 1, further comprising a biasing device comprising a third center.

14. The hysteresis device assembly of claim 13, wherein the biasing device is a Belleville spring.

15. The hysteresis device assembly of claim 13, wherein the tab prevents the third center of the biasing device from moving past a point in a radial direction away from the axis.

16. The hysteresis device assembly of claim 13, wherein the first spacer plate engages the second spacer plate.

17. The hysteresis device assembly of claim 13, wherein the biasing device is configured to damp vibrations.

18. The hysteresis device assembly of claim 1, further comprising:
a slot on the hub; and
a projection on the second spacer plate,
wherein the projection on the second spacer plate engages a slot on the hub.

19. The hysteresis device assembly of claim 1, further comprising a third spacer plate, wherein the tab engages the third spacer plate.

20. The hysteresis device assembly of claim 19, wherein the stack plate is located between the first spacer plate and the third spacer plate.

21. The hysteresis device assembly of claim 20, further comprising:
a fourth spacer plate;
a fifth spacer plate;
a sixth spacer plate;
wherein the hub engages the second spacer plate, the fourth spacer plate, the fifth spacer plate, and the sixth spacer plate.

22. The hysteresis device assembly of claim 21, wherein the stack plate is located between the fourth spacer plate and the fifth spacer plate.

23. The hysteresis device assembly of claim 22, wherein the stack plate is configured to transmit torque to the tabbed washer thereby rotating the tabbed washer about the axis.

24. The hysteresis device assembly of claim 23, wherein the tabbed washer is configured to transmit torque to the first spacer plate thereby rotating the first spacer plate about the axis.

25. The hysteresis device assembly of claim 24, wherein the first spacer plate is configured to rotate relative to the second spacer plate about the axis.

26. A damper disc assembly comprising;
a first main-damper cover plate;
a second main-damper cover plate;
a biasing device located between the first main-damper cover plate and the second main-damper cover plate;
a torsional spring;
the hysteresis device assembly of claim 1 located between the first main-damper cover plate and the second main-damper cover plate; and
at least one friction disc connected to the stack plate.

27. The damper disc assembly of claim 26, wherein the biasing device is biased against the second main-damper cover plate.

28. The damper disc assembly of claim 27, wherein the tabbed washer abuts the first main-damper cover plate.

29. A damper disc assembly comprising;
a first main-damper cover plate;
a second main-damper cover plate;
a biasing device located between the first main-damper cover plate and the second main-damper cover plate;
a torsional spring;
the hysteresis device assembly of claim 25 located between the first main-dam per cover plate and the second main-damper cover plate; and
at least one friction disc connected to the stack plate,
wherein the tabbed washer abuts the first main-damper cover plate, the second spacer plate abuts the tabbed washer, the first spacer plate abuts the second spacer plate, the fourth spacer plate abuts the first spacer plate, the stack plate abuts the fourth spacer plate, the fifth spacer plate abuts the stack plate, the third spacer plate abuts the fifth spacer plate, the sixth spacer plate abuts the third spacer plate, the biasing device abuts the sixth spacer plate, and the second main-damper cover plate abuts the biasing device.
